(19) United States
(12) Patent Application Publication
(10) Pub. No.: US 2025/0282064 A1
(43) Pub. Date: Sep. 11, 2025

(54) Articulated Multi-Zone Robot End Effector Systems and Methods for High Moment Loads

(71) Applicant: CONTORO INC., Austin, TX (US)

(72) Inventors: Rohit John Varghese, Austin, TX (US); Tyler Watts, Austin, TX (US); Nick Moser, Austin, TX (US); Ashwin Hingwe, Austin, TX (US); Mincheol Kim, Austin, TX (US); Jay Lee, Austin, TX (US); Youngmok Yun, Austin, TX (US)

(21) Appl. No.: 19/072,285

(22) Filed: Mar. 6, 2025

Related U.S. Application Data
(60) Provisional application No. 63/562,844, filed on Mar. 8, 2024.
(60) Provisional application No. 63/571,962, filed on Mar. 29, 2024.

(51) Int. Cl. B25J 15/06

(52) U.S. Cl. CPC B25J 15/0625

(57) ABSTRACT

An embodiment includes a system comprising: a first zone of suction apertures coupled to a first distance sensor; a second zone of suction apertures coupled to a second distance sensor; a robotic arm coupled to the first and second zones of suction apertures; wherein: (a) the first zone of suction apertures is arranged in a first plane, and (b) the second zone of suction apertures is arranged in a second plane that is non-coplanar with the first plane. Other embodiments are described herein.

### CROSS-REFERENCE TO RELATED APPLICATION

This application claims priority to both: (1) U.S. Provisional Patent Application No. 63/562,844 filed on Mar. 8, 2024 and entitled “Articulated Multi-Zone Robot End Effector for High Moment Loads”, and (2) U.S. Provisional Patent Application No. 63/571,962 filed on Mar. 29, 2024 and entitled “Articulated Multi-Zone Robot End Effector Systems for High Moment Loads”. The contents of both applications are hereby incorporated by reference.

### TECHNICAL FIELD

Embodiments of the invention are in the field of robotics.

### BACKGROUND

Organizations continue looking for ways to boost the speed, reliability, flexibility, and productivity of their warehouse and distribution operations. Automation has emerged as a key component to that end. Automation promises to help organizations tackle pressing supply chain problems: addressing labor challenges, improving fulfillment quality and safety, maximizing space utilization, and increasing throughput.

Supply chain managers can now choose from a wide range of mature, capable, reliable solutions to match their needs, including high-density storage and retrieval systems, goods-to-person robots, and collaborative robots that can work safely alongside their human colleagues. Automation providers have therefore refined and segmented their technologies to meet different demand scenarios. In the material-movement category, for example, autonomous mobile robot (AMR) systems are primarily used for piece-pick or, more recently, full-pallet operations.

### BRIEF DESCRIPTION OF THE DRAWINGS

Features and advantages of embodiments of the present invention will become apparent from the appended claims, the following detailed description of one or more example embodiments, and the corresponding figures. Where considered appropriate, reference labels have been repeated among the figures to indicate corresponding or analogous elements.

FIG. 1 depicts an embodiment of a robotic arm with a grasping tool as its end effector.

FIG. 2 is an image of an embodiment of a robotic arm adjacent a boxwall.

FIG. 3 is an image of an embodiment of a grasping tool with a base that attaches to a robot. FIG. 3 further shows a loadcell (3), Zone1 (1), Zone2 (2), and sensors/cameras (4).

FIG. 4 is an image of an embodiment of a grasping tool with a gripper zone showing a vacuum chamber, section cups, laser distance sensor (4), and check valves (11).

FIG. 5 is an image of an embodiment of a grasping tool with Zone1 fixed and Zone2 articulated.

FIG. 6A is an image of an embodiment of a grasping tool with Zone1 in a translated state and Zone2 in an articulated state. FIG. 6B also shows the recessed distance of Zone2 in the open position.

FIGS. 7A, 7B, 7C are images of an embodiment of a grasping tool with a mechanical linkage and toggle points for moving Zone2 between recessed (FIG. 7A), transition (FIG. 7B), and articulated (FIG. 7C) states.

FIG. 8 is an image of an embodiment of a grasping tool with a gripper camera section in a protected volume/space between the two zones (e.g., Zone1 and Zone2).

FIG. 9 is an embodiment of circuitry represented by a circuit diagram showing time delay relays to enable high actuation current for motors on the linkage mechanism.

FIG. 10 is an image of an embodiment of a grasping tool grasping a box.

FIG. 11 is an embodiment a system represented by a pneumatic block diagram showing valves, splitters, and vacuum components for controlling suction to the gripper.

FIG. 12, 13, 14 illustrate systems for implementing instructions and controlling and/or operating embodiments of grasping tool embodiments addressed herein.

FIG. 15 is an image of an embodiment of a grasping tool engaged in bottom shelf grasping.

FIG. 16 is a flow chart of an embodiment of instructions (e.g., to be implemented as logic/machine operations) to enable bottom shelf grasping via a grasping tool.

FIG. 17 is an image of an embodiment of a grasping tool engaged in top/side shelf grasping.

FIG. 18 is a flow chart of an embodiment of instructions (e.g., to be implemented as logic/machine operations) to enable top/side shelf grasping.

FIG. 19 is an image of an embodiment of a grasping tool engaged in advanced bottom shelf grasping.

FIG. 20 is a flow chart of an embodiment of instructions (e.g., to be implemented as logic/machine operations) to enable advanced bottom shelf grasping.

FIG. 21 is an image of an embodiment of a grasping tool engaged in advanced top/side grasping.

FIG. 22 is a flow chart of an embodiment of instructions (e.g., to be implemented as logic/machine operations) to enable advanced top/side grasping.

FIGS. 23A, 23B are images of an embodiment of a grasping tool with Zone1 in a non-translated state (FIG. 23A) and a translated state (FIG. 23B).

FIG. 24 is an exploded view of an embodiment of a linkage assembly coupling two zones of suction cups to one another with an articulation point or pivot (29) for mechanical misalignment compliance.

FIGS. 25A, 25B, 25C illustrate a embodiment of a misalignment compensation system for an articulating zone of suction cups. FIG. 25D is a sectional view showing resilient members to return Zone2's suction cups to a baseline location.

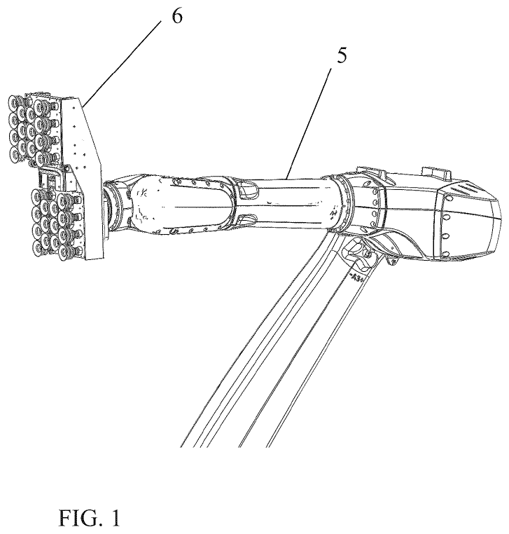

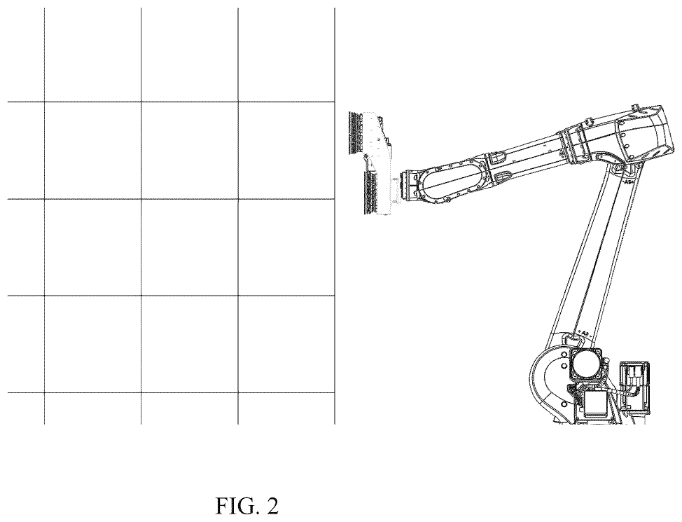

### DETAILED DESCRIPTION

Reference will now be made to the drawings wherein like structures may be provided with like suffix reference designations. In order to show the structures of various embodiments more clearly, the drawings included herein are diagrammatic representations of structures. Thus, the actual appearance of the fabricated structures, for example in a photo, may appear different while still incorporating the claimed structures of the illustrated embodiments (e.g., walls may not be exactly orthogonal to one another in actual fabricated devices). Moreover, the drawings may only show the structures useful to understand the illustrated embodiments. Additional structures known in the art may not have been included to maintain the clarity of the drawings. For example, not every layer of a device is necessarily shown. “An embodiment”, “various embodiments” and the like indicate embodiment(s) so described may include particular features, structures, or characteristics, but not every embodiment necessarily includes the particular features, structures, or characteristics. Some embodiments may have some, all, or none of the features described for other embodiments. “First”, “second”, “third” and the like describe a common object and indicate different instances of like objects are being referred to. Such adjectives do not imply objects so described must be in a given sequence, either temporally, spatially, in ranking, or in any other manner. Further, recitation of a “first” element does not necessarily mean a “second” element exists. “Connected” may indicate elements are in direct physical or electrical contact with each other and “coupled” may indicate elements co-operate or interact with each other, but they may or may not be in direct physical or electrical contact. Phrases such as comprising or using “at least one of A or B” include situations with A, B, or A and B.

Applicant determined several problems continue to hold back material-movement robotic-based applications. For example, Applicant noted that as a robot moves an object such as a box in a warehouse, the robot goes through a range of different orientations and accelerations. When boxes are gripped from the side, there is potentially a large moment applied to the robot's gripper, causing the box to peel away from the gripper. The corrugated cardboard material that is commonly used for boxes in the logistics industry is also highly porous and limits the vacuum pressure that is possible to apply further complicating the problem.

This effect of a high moment load is particularly pronounced for boxes that are both heavy and simultaneously long in the dimension perpendicular to the face that the gripper needs to approach from (since the moment load is equal to the weight of the box multiplied by the perpendicular distance). One method of countering the moment load is to increase the size of the gripper face which both increases the total suction force as well as the moment applied by the gripper to counter the moment load, but Applicant noted this technique has limitations for the boxes that have a narrow or small sized face on the side that the gripper approaches from (for example a long but narrow box that needs to be grasped on one of the small faces at the end).

### Systems

To address these problems, an embodiment includes a vacuum-based grasping tool (also called a gripper), capable of: (a) grasping porous box shaped objects (such as cardboard boxes) that are large and heavy, and (b) maintaining a secure hold as the object is manipulated in multiple orientations. The base of the grasping tool (also called a gripper base) is attached to the end of a robotic arm which moves the grasping tool in 3D space to achieve manipulation.

An embodiment of the grasping tool has two gripper zones (Zone1 and Zone2), each comprising multiple suction cups (or other orifices for vacuum) arranged on a plane. The suction cups are attached to a chamber to which vacuum can be supplied to turn on or activate the zone.

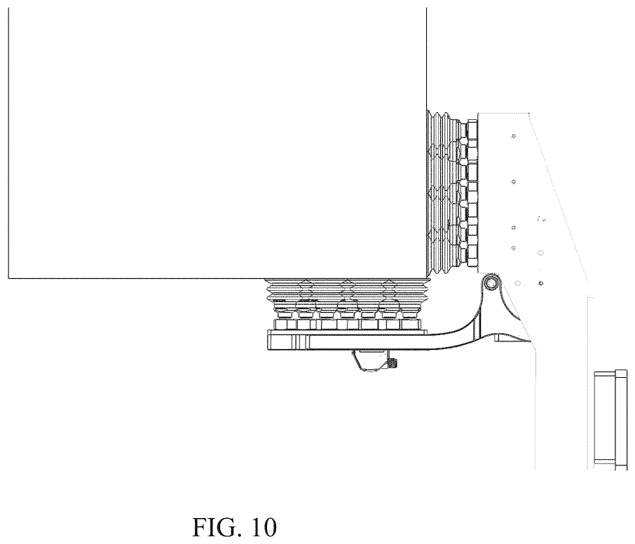

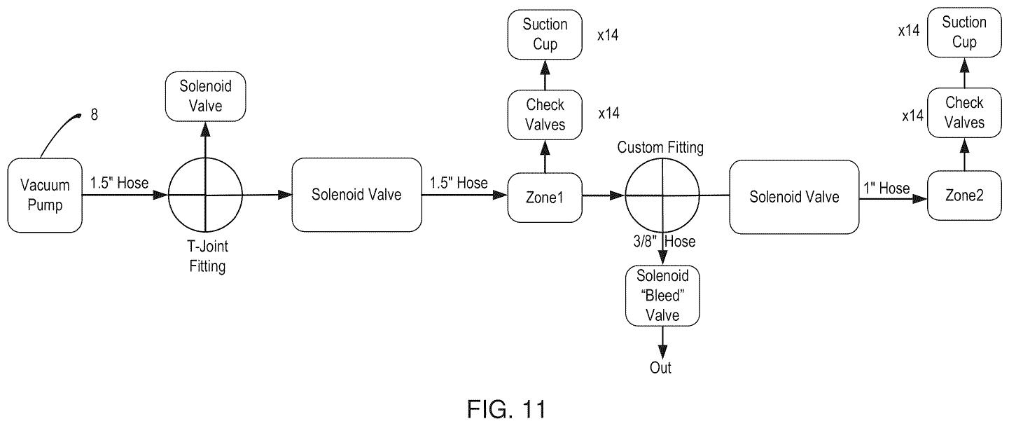

The two zones can be moved relative to each other to achieve grasp configurations that are able to react to high moment loads. These zones are relatively small in comparison to the weight capacity that is usually associated with vacuum grippers for the weight. The zone sizes can be kept relatively small because splitting the gripper surface into multiple sections/zones allows the zones to be movable with respect to one another and to have a distance between the zones increase. As the distance between the zones increases, the length of the moment arm between the zones also increases, thereby enabling the gripper to counteract higher moment loads. Also, because the zones are separate from each other and movable in orientation relative to each other, the gripper zones may apply a combination of compression (e.g., box weight compressing Zone2 in FIG. 10), suction or tension (e.g., if the arm in FIG. 10 is inverted 180 degrees and Zone2 is applying suction to a box that is pulling away from Zone2), and shear loading (e.g., Zone1 in FIG. 10) between the zones. This is a notable improvement over conventional single plane grippers that apply only one type of loading (e.g., suction) depending on the orientation. The combination of loading in multiple directions can help stabilize the box against inertial forces when the box is accelerated in 3D space. Additionally, loading in the shear direction can provide high holding strength only when the effect of peeling away from the surface is counteracted. Additional zones in different orientations are capable of performing this role.

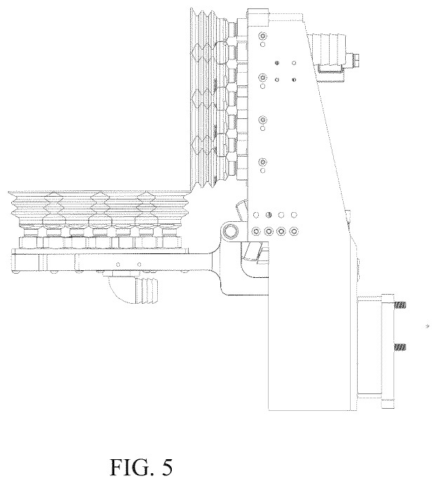

In a first embodiment, Zone1 is fixed relative to the base of the grasping tool. However, Zone2 can articulate relative to the base of the grasping tool to change its orientation by up to 90 degrees from the open position (parallel to Zone1) to the closed position (perpendicular to Zone2). See, for example, FIG. 5.

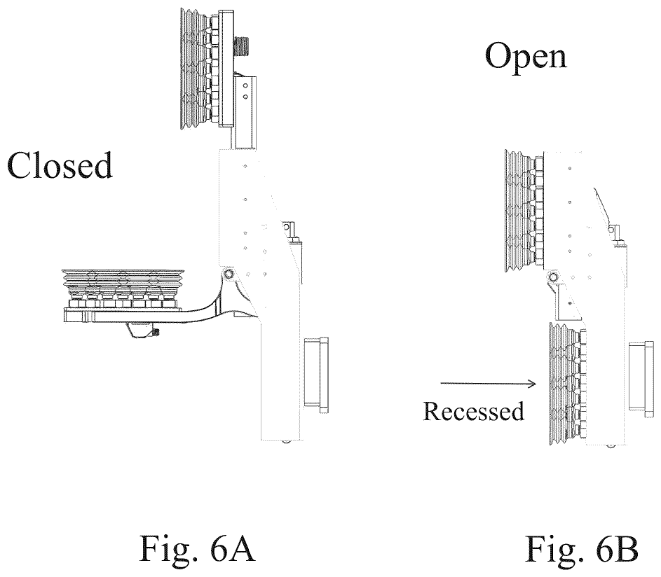

In a second embodiment, Zone1 can translate relative to the base of the grasping tool to move away from Zone2. Zone2 articulates in the same manner as the first embodiment but may also be recessed behind the plane of Zone1 when in the open position. See, for example, FIG. 6B.

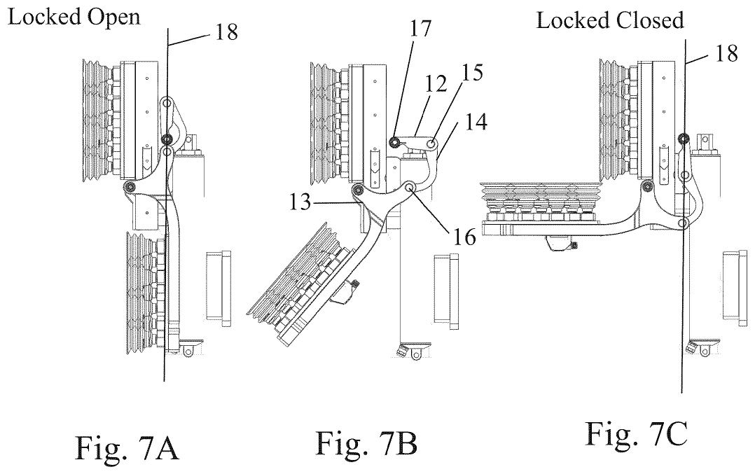

A mechanical linkage mechanism moves the zones relative to each other and uses linkage structures to achieve a toggle point at both desired configurations of the zone, which is a self-locking position that achieves a high holding force without needing extremely strong actuators. This is primarily used for the articulation of Zone2. For example, FIGS. 7A, 7B, 7C show the linkage structure in these points. FIGS. 7A and 7C show the linkage in the two toggle positions (locked open and locked closed respectively). FIG. 7B shows the linkage while it is moving between the toggle positions and not in a toggle position. Toggle positions are unique configurations between the driving link (which is connected to the motor), the output link (which is connected to the output load), and the connecting link (which links the driving link to the output link). The toggle positions are those where the connecting link is aligned parallel to the driving link. The mechanical advantage of the linkage system varies depending on the configuration of the links, increasing exponentially in the vicinity of the toggle position, allowing a very low motor force to counter a high output load. Additionally, when the linkage system has a range of motion that goes past the toggle position, loading on the output link pushes the driving link further past the toggle point towards the hard stop and achieves a self-locking behavior.

An embodiment employs time delay relays for the actuation of the linkage mechanism. The relays enable the motors to receive a high current during the first few seconds of activation to move the mechanism through its stroke, but then reduce the current to a small value after the mechanism has reached its toggle locking point. This small current provides a minimum torque to ensure that vibration or bumps to the whole grasping tool do not move the mechanism out of its toggle locking position while conserving power and not generating excessive heat.

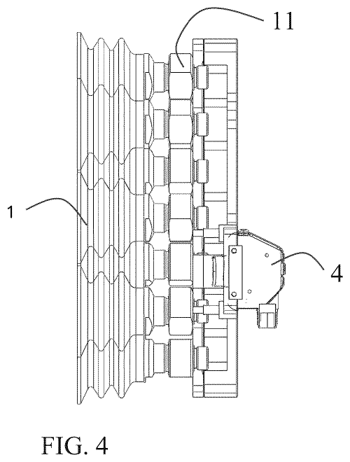

An embodiment may employ check valves on individual suction cups of each zone to prevent the escape of air from any suction cup that is not covered by a box face and thus prevent the loss of pressure to the rest of the system. See, for example, FIG. 4.

An embodiment may have one or more distance sensors mounted within each zone which allow accurate measurement of the distance to the box during approach which is useful during the grasping strategy.

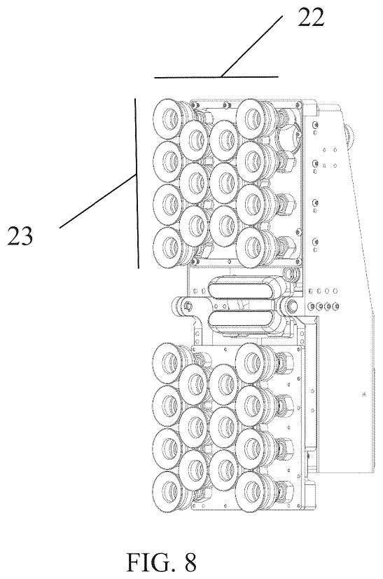

An embodiment may have sensor systems including cameras, RGBD cameras, depth sensors, combinations thereof, or other sensing systems mounted to the grasping tool in a protected volume/space between Zone1 and Zone2. See, for example, FIG. 8.

An embodiment may have a force sensor with at least 3 orthogonal axes of measurement at the gripper base. The sensor may measure the reaction force applied between the grasping tool and the robot arm. This sensor may be used to measure the weight of the boxes that are grasped by the tool.

An embodiment may have mechanical compliance of individual suction cups that makes the grasping tool capable of accommodating misalignment in approach of the gripper to the edge and face of the box. This compliance also allows some relative movement between the box and the gripper when only one zone is in contact, which is useful for the grasping strategy.

Embodiments provide advantages over conventional systems in at least three ways.

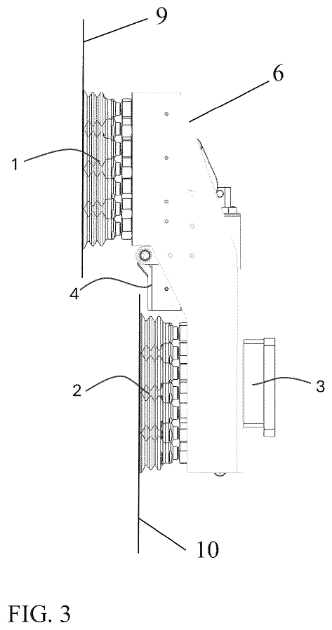

First, conventional systems may contain suction elements in a single plane, analogous to Zone1 of FIG. 3. However, the length of the moment arm in conventional systems is limited to the length of the side of the single zone. The only way to increase the moment arm in the conventional systems is to use a larger gripper, which would have difficulties accessing smaller boxes or tight spaces. Embodiments, in contrast, use zones of suction elements that exist in different planes. For example, see FIGS. 3, 5, 6A-6B.

Second, multiple articulating zones of embodiments described herein enable the embodiments to apply high moment loads where necessary, while still being able to hold a small form factor in situations where it is necessary. For example, see FIGS. 3, 5, 6A-6B.

Third, an embodiment includes a linkage mechanism that enables self-locking of the zones in their intended positions without requiring the application of high torque and high current motors. For example, see FIGS. 7A, 7B, 7C.

### Methods

An embodiment includes grasping strategies.

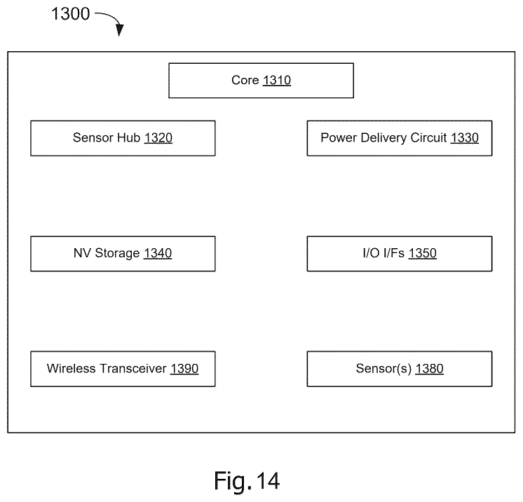

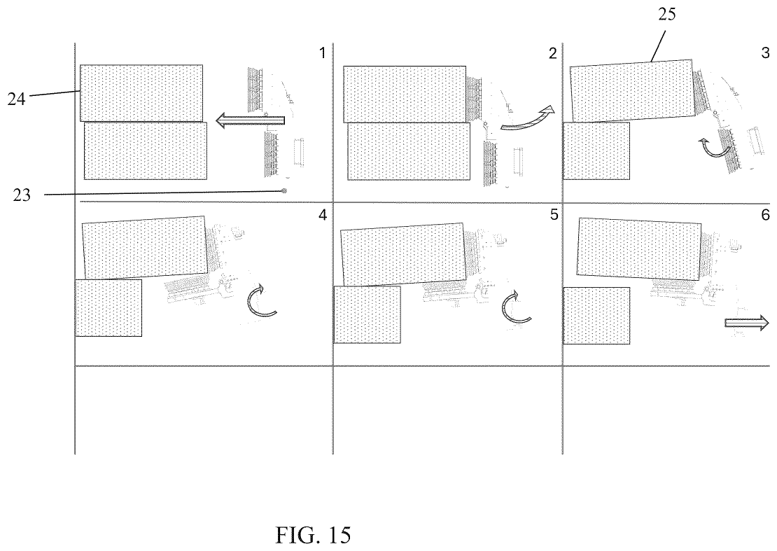

An embodiment is a method for bottom shelf grasping, which includes a grasping strategy that may be used with, for example, the two-zone gripper embodiments addressed above. For example, see FIG. 15.

The grasping tool is positioned to first contact Zone1 to a vertical face of the box. Input from the laser distance sensor on Zone1 may be used as feedback for accurate approach path. See FIG. 15, step 1. The grasping tool then grasps the box by turning on the vacuum on Zone1. The gripper base is moved upwards and towards the robot (away from the box's original location). See FIG. 15, steps 2-3. This movement exposes the lower surface of the box so that the Zone2 can be articulated into contact with it and grasp.

During the above movement the gripper base is also simultaneously tilted towards the box (See FIG. 15, step 3) which allows the mechanical compliance of the suction cups to angle the bottom surface away from the target position of Zone2. For example, note how in FIG. 15, step 3 the upper suction cups of Zone1 are more fully compressed than the lower suction cups of Zone1. As a result, the situation is better addressed when, for example, Zone1 is located too high up the sidewall of the box. In this case, Zone2 would not be able to full close and thereby enable the locking mechanism described above (e.g., FIGS. 7A, 7B, 7C). If a motor is kept small to lower energy consumption and/or overall space occupied by the arm, such a smaller motor may not be able to move the box up so that Zone2 can become locked. However, due to the tilt of the gripper base (See FIG. 15, step 3) and/or mechanical compliance of Zone1 (See FIG. 15, step 3) a tolerance is supplied so Zone2 can enter into a locked state which would otherwise be prevented by the box lower surface being too close to Zone2 (because Zone1 was located too high on the side of the box wall). This enables the linkage mechanism to move Zone2 into the desired locked position without interference from the box that may prevent the mechanism from reaching its self-locking toggle point. See FIG. 15, step 4. Zone2 compliance also facilitates locking of Zone2. See FIG. 15, step 5.

After Zone2 has reached its self-locking toggle point, the gripper base is tilted back away from the box to bring Zone2 into contact with the bottom surface of the box and Zone2 is activated to grasp the box. See FIG. 15, step 5. The gripper base is tilted further back to now lift the box off the boxwall. See FIG. 15, step 6. The gripper now has securely grasped the box and can be moved by the robotic arm to manipulate it in 3D space.

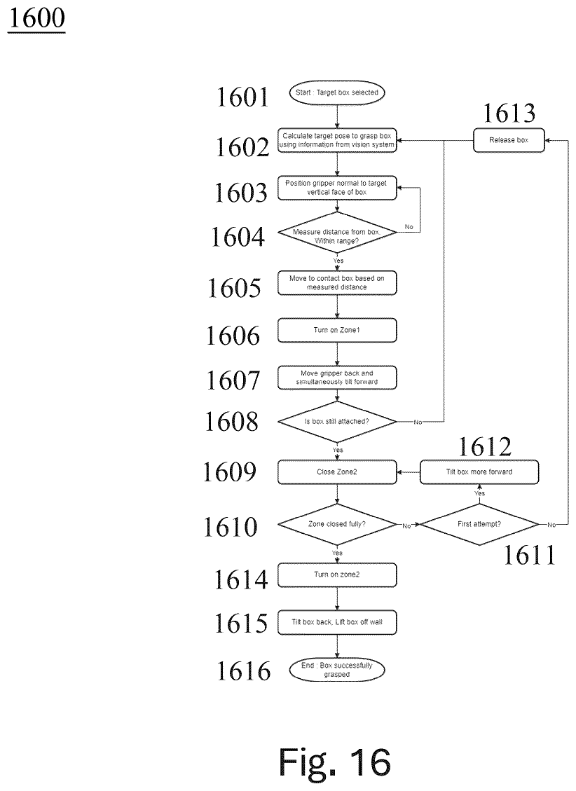

See also, for example, FIG. 16.

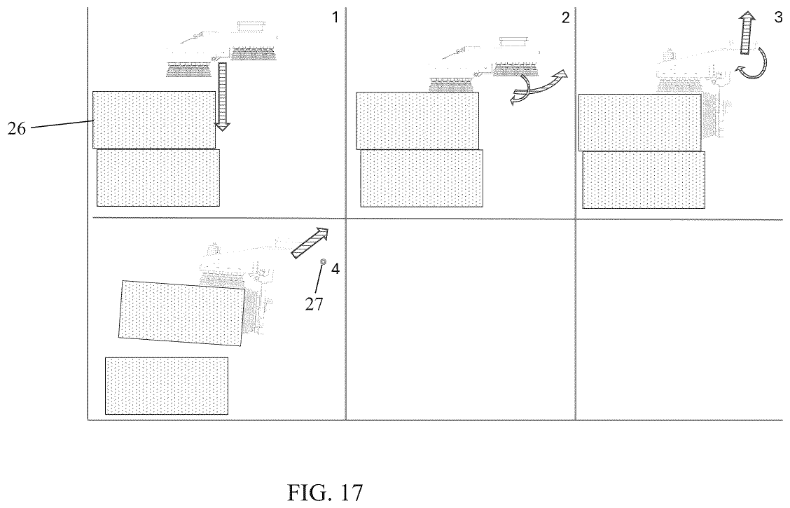

An embodiment is a method for top/side shelf grasping, which includes a grasping strategy that may be used with, for example, the two-zone gripper embodiments addressed above. The grasping tool is positioned to first contact Zone1 to a top/side face of the box. Sec FIG. 17, step 1. Input from the laser distance sensor on Zone1 may be used as feedback for an accurate approach path. The grasping tool then grasps the box by turning on the vacuum on Zone1. The vision system checks whether Zone2 can reach the self-locking toggle point without interference from the surrounding environment.

If Zone2 cannot reach the toggle point (not illustrated), the gripper base is tilted to angle the target position of Zone2 away from the top/side of the box. The mechanical compliance of the suction cups enables Zone1 to remain attached during this process. This is analogous to FIG. 15, steps 4-5, but with the gripper base reoriented 90 degrees to approach a top of a box instead of a side of a box. The mechanical compliance and tilting enables the mechanical linkage mechanism to move Zone2 into position without needing to compress the box before the mechanism reaches its self-locking toggle point (where compression may require too large a motor to close Zone2). After Zone2 has reached its self-locking toggle point, the gripper base is tilted to bring Zone2 into contact with the top/side surface of the box, and Zone2 is then activated to grasp the box. This is analogous to FIG. 15, step 5. The gripper base is then lifted straight upwards to lift the box off the boxwall. The gripper now has securely grasped the box and can be moved by the robotic arm to manipulate it in 3D space.

If Zone2 cannot reach the toggle point (not illustrated) the gripper base is moved upwards and towards the robot (away from the box's original location). This movement exposes the adjacent surface of the box so that Zone2 can be articulated into contact with it and grasp. During the above movement the gripper base is also simultaneously tilted towards the box which allows the mechanical compliance of the suction cups to angle the adjacent surface away from the target position of Zone2. This enables the linkage mechanism to move Zone2 into the desired position without interference from the box that may prevent the mechanism from reaching its self-locking toggle point. After Zone2 has reached its self-locking toggle point, the gripper base is tilted back away from the box to bring Zone2 into contact with the adjacent surface of the box and Zone2 is activated to grasp the box. This is analogous to FIG. 15, steps 4-5, but with the gripper base reoriented 90 degrees to approach a top of a box instead of a side of a box. The gripper base is tilted further back to now lift the box off the boxwall. This is analogous to FIG. 15, step 6. The gripper now has securely grasped the box and can be moved by the robotic arm to manipulate it in 3D space.

FIG. 17 addresses an additional embodiment of a method for top/side box grasping. FIG. 17 addresses lifting without the use of mechanical compliance in Zone1 coupled with tilting before attaching Zone2 to the box (as addressed above).

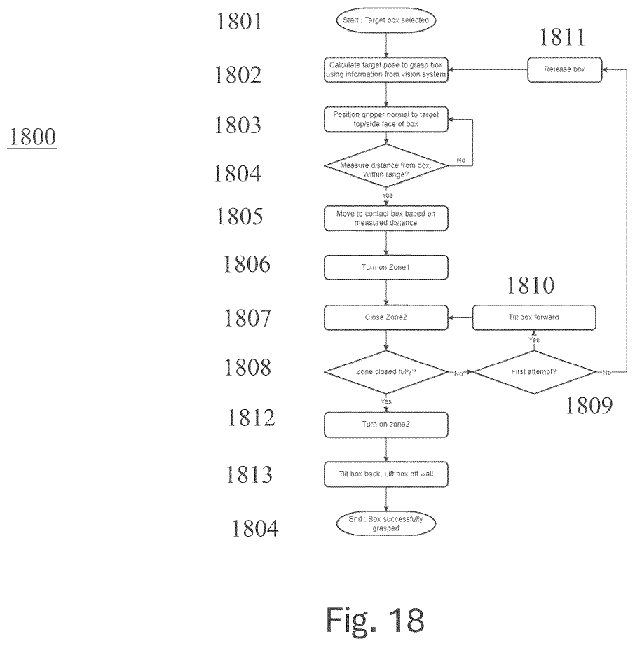

FIG. 18 addresses an additional embodiment of a method for top/side box grasping.

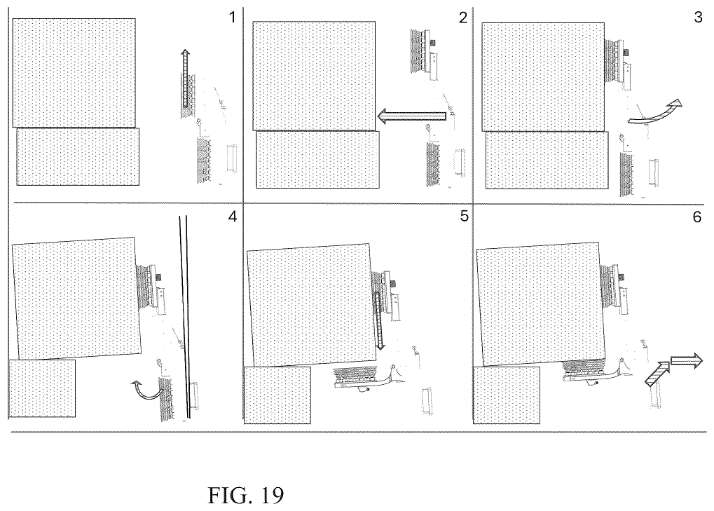

FIG. 19 addresses an embodiment for advanced bottom shelf grasping, which is a grasping strategy that may use an embodiment a two-zone gripper such as that shown in FIG. 6.

Zone1 of the grasping tool is translated outward staying within a limit that the distance between the end of Zone1 and the closed position of Zone2 does not exceed the height of the box. See FIG. 19, step 1. The grasping tool is positioned to contact Zone1 to a vertical face of the box while ensuring that Zone2 is aligned such that it can lightly contact the bottom face of the box or be very close to it when moved into closed position. See FIG. 19, step 2. Input from the laser distance sensor on Zone1 may be used as feedback for accurate approach path. Input from the vision system may be used to ensure alignment of the edge with Zone2. The grasping tool then grasps the box by turning on the vacuum on Zone1. The gripper base is moved upwards and towards the robot (away from the box's original location). See FIG. 19, steps 3-4. This movement exposes the bottom surface of the box so that Zone2 can be articulated into contact with it and grasp it.

During the above movement the gripper base is also simultaneously tilted towards the box which allows the mechanical compliance of the suction cups to angle the bottom surface away from the target position of Zone2. See FIG. 19, step 4. This enables the linkage mechanism to move Zone2 into the desired position without interference from the box that may prevent the mechanism from reaching its self-locking toggle point. Zone2 is now moved into the closed position to contact the box. Zone1 may be moved towards Zone2 to force the box (or alternatively simultaneously move the gripper base toward the box) to better contact Zone2. See FIG. 19, step 5. Input from the laser distance sensor on Zone2 may be used for feedback of magnitude of movement required. Zone2 is then activated to grasp the box. The gripper base is then lifted upwards to lift the box off the boxwall. See FIG. 19, step 6. The gripper now has securely grasped the box and can be moved by the robotic arm to manipulate it in 3D space.

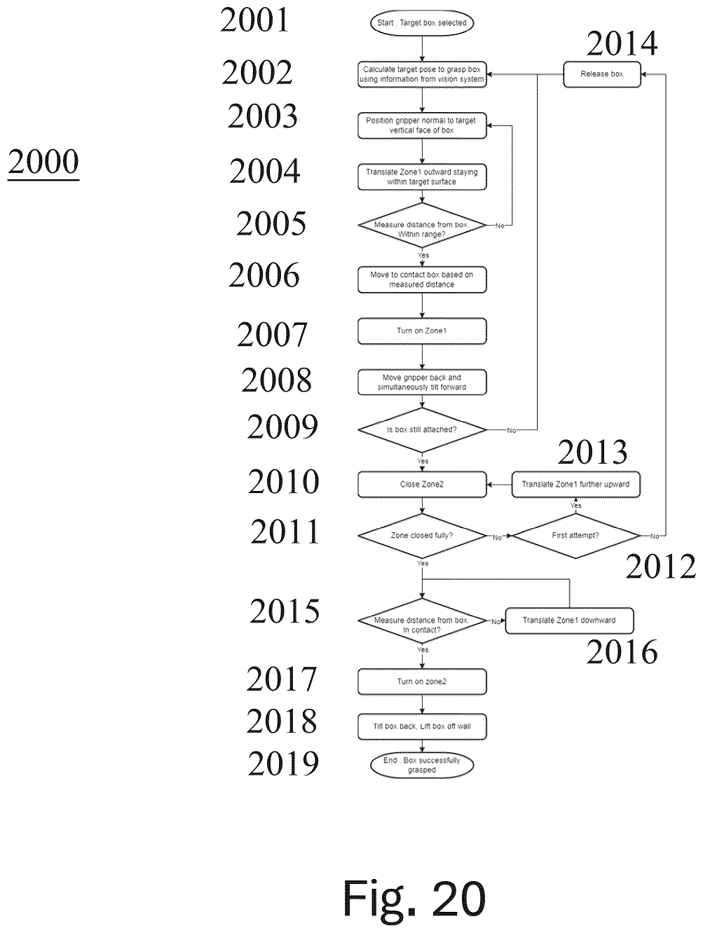

FIG. 20 includes another embodiment involving translation of Zone1.

An embodiment addresses a method for advanced top/side shelf grasping, which is a grasping strategy that uses an embodiment with translation such as the two-zone gripper of FIGS. 6A-6B.

Zone1 of the grasping tool is translated outward staying within a limit that the distance between the end of Zone1 and the closed position of Zone2 does not exceed the depth of the box. This is analogous to FIG. 19, step 1, but with the gripper base reoriented 90 degrees to approach a top of a box instead of a side of a box. The grasping tool is positioned to contact Zone1 to a top/side face of the box while ensuring that Zone2 is aligned such that it can lightly contact the adjacent face of the box or be very close to it when moved into closed position. This is analogous to FIG. 19, step 2. Input from the laser distance sensor on Zone1 may be used as feedback for accurate approach path. Input from the vision system may be used to ensure alignment of the edge with Zone2.

The grasping tool then grasps the box by turning on the vacuum on Zone1. The vision system checks whether Zone2 can reach the self-locking toggle point without interference from the surrounding environment.

If Zone2 can reach the toggle point, Zone2 is now moved into the closed position to contact the box. Zone1 may be moved towards Zone2 to force the box (or alternatively simultaneously move the gripper base toward the box) to better contact Zone2. This is analogous to FIG. 19, steps 4-5. Input from the laser distance sensor on Zone2 may be used for feedback of magnitude of movement required. Zone2 is then activated to grasp the box. The gripper base is then lifted upwards to lift the box off the boxwall. The gripper now has securely grasped the box and can be moved by the robotic arm to manipulate it in 3D space.

If Zone2 cannot reach the toggle point, the gripper base is moved upwards and towards the robot (away from the box's original location). This is analogous to FIG. 15, step 3. This movement exposes the adjacent surface of the box so that Zone2 can be articulated into contact with it and grasp. During the above movement the gripper base is also simultaneously tilted towards the box which allows the mechanical compliance of the suction cups to angle the adjacent surface away from the target position of Zone2. This is analogous to FIG. 15, step 3. This enables the linkage mechanism to move Zone2 into the desired position without interference from the box that may prevent the mechanism from reaching its self-locking toggle point. Zone2 is now moved into the closed position to contact the box. This is analogous to FIG. 15, step 4. Zone1 may be moved towards Zone2 to force the box (or alternatively simultaneously move the gripper base toward the box) to better contact Zone2. This is analogous to FIG. 19, step 5. Input from the laser distance sensor on Zone2 may be used for feedback of magnitude of movement required. Zone2 is then activated to grasp the box. The gripper base is then lifted straight upwards to lift the box off the boxwall. The gripper now has securely grasped the box and can be moved by the robotic arm to manipulate it in 3D space.

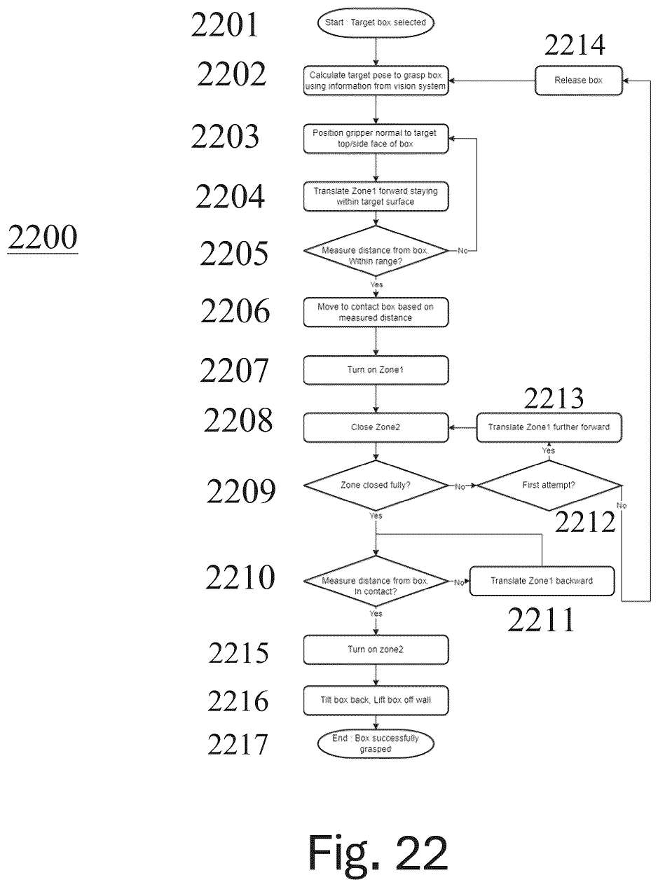

FIG. 22 includes another embodiment involving translation of Zone1.

In conventional systems, grasping strategies typically involve positioning on a box surface, activating the vacuum and then moving away with the assumption that the box is grasped. These techniques require precise prior estimation of the box position and accurate positioning of the gripper tool. In contrast, the techniques of embodiments described herein enable grasping while accounting for positioning errors by the use phased steps and observing responses with sensors on the gripper faces. The enables grasping even with poorer estimation of the box positions.

While methods have been described herein with regard to certain figures, those are methods are not necessarily tied to the figures and nor are the figures necessarily tied to the written descriptions of the specification.

### Computer Systems

The following includes hardware and logic systems that can be used in embodiments to, for example, manipulate Zone1 and/or Zone2, apply suction and/or compression within Zone1 and/or Zone2 (or within subportions of Zone1 and/or Zone2).

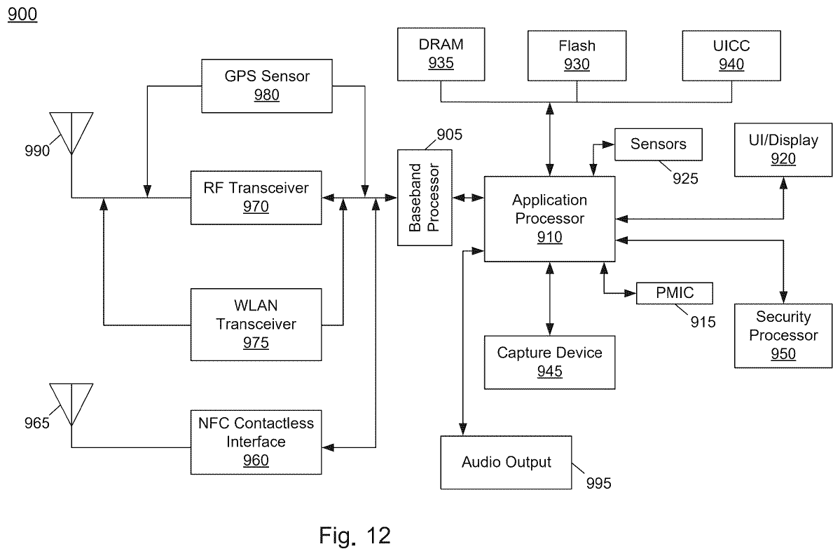

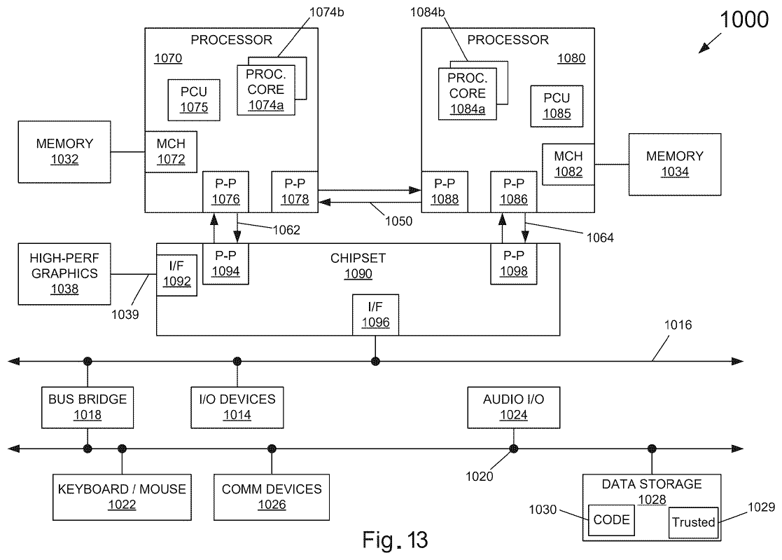

FIG. 12 includes a block diagram of an example system with which embodiments can be used. As seen, system 900 may be a smartphone or other wireless communicator or any other Internet of Things (IoT) device. A baseband processor 905 is configured to perform various signal processing with regard to communication signals to be transmitted from or received by the system. In turn, baseband processor 905 is coupled to an application processor 910, which may be a main CPU of the system to execute an OS and other system software, in addition to user applications such as many well-known social media and multimedia apps. Application processor 910 may further be configured to perform a variety of other computing operations for the device.

In turn, application processor 910 can couple to a user interface/display 920 (e.g., touch screen display). In addition, application processor 910 may couple to a memory system including a non-volatile memory, namely a flash memory 930 and a system memory, namely a DRAM 935. As further seen, application processor 910 also couples to a capture device 945 such as one or more image capture devices that can record video and/or still images.

A universal integrated circuit card (UICC) 940 comprises a subscriber identity module, which in some embodiments includes a secure storage to store secure user information. System 900 may further include a security processor 950 (e.g., Trusted Platform Module (TPM)) that may couple to application processor 910. A plurality of sensors 925, including one or more multi-axis accelerometers may couple to application processor 910 to enable input of a variety of sensed information such as motion and other environmental information. In addition, one or more authentication devices may be used to receive, for example, user biometric input for use in authentication operations.

As further illustrated, a near field communication (NFC) contactless interface 960 is provided that communicates in a NFC near field via an NFC antenna 965. While separate antennae are shown, understand that in some implementations one antenna or a different set of antennae may be provided to enable various wireless functionalities.

A power management integrated circuit (PMIC) 915 couples to application processor 910 to perform platform level power management. To this end, PMIC 915 may issue power management requests to application processor 910 to enter certain low power states as desired. Furthermore, based on platform constraints, PMIC 915 may also control the power level of other components of system 900.

To enable communications to be transmitted and received such as in one or more internet of things (IoT) networks, various circuits may be coupled between baseband processor 905 and antenna 990. Specifically, a radio frequency (RF) transceiver 970 and a wireless local area network (WLAN) transceiver 975 may be present. In general, RF transceiver 970 may be used to receive and transmit wireless data and calls according to a given wireless communication protocol such as 5G wireless communication protocol such as in accordance with a code division multiple access (CDMA), global system for mobile communication (GSM), long term evolution (LTE) or other protocol. In addition, a GPS sensor 980 may be present, with location information being provided to security processor 950. Other wireless communications such as receipt or transmission of radio signals (e.g., AM/FM) and other signals may also be provided. In addition, via WLAN transceiver 975, local wireless communications, such as according to a Bluetooth™ or IEEE 802.11 standard can also be realized.

FIG. 13 shows a block diagram of a system in accordance with another embodiment of the present invention. Multiprocessor system 1000 is a point-to-point interconnect system such as a server system, and includes a first processor 1070 and a second processor 1080 coupled via a point-to-point interconnect 1050. Each of processors 1070 and 1080 may be multicore processors such as SoCs, including first and second processor cores (i.e., processor cores 1074a and 1074b and processor cores 1084a and 1084b), although potentially many more cores may be present in the processors. In addition, processors 1070 and 1080 each may include power controller unit 1075 and 1085. In addition, processors 1070 and 1080 each may include a secure engine to perform security operations such as attestations, IoT network onboarding or so forth.

First processor 1070 further includes a memory controller hub (MCH) 1072 and point-to-point (P-P) interfaces 1076 and 1078. Similarly, second processor 1080 includes a MCH 1082 and P-P interfaces 1086 and 1088. MCH's 1072 and 1082 couple the processors to respective memories, namely a memory 1032 and a memory 1034, which may be portions of main memory (e.g., a DRAM) locally attached to the respective processors. First processor 1070 and second processor 1080 may be coupled to a chipset 1090 via P-P interconnects 1062 and 1064, respectively. Chipset 1090 includes P-P interfaces 1094 and 1098.

Furthermore, chipset 1090 includes an interface 1092 to couple chipset 1090 with a high-performance graphics engine 1038, by a P-P interconnect 1039. In turn, chipset 1090 may be coupled to a first bus 1016 via an interface 1096. Various input/output (I/O) devices 1014 may be coupled to first bus 1016, along with a bus bridge 1018 which couples first bus 1016 to a second bus 1020. Various devices may be coupled to second bus 1020 including, for example, a keyboard/mouse 1022, communication devices 1026 and a data storage unit 1028 such as a non-volatile storage or other mass storage device. As seen, data storage unit 1028 may include code 1030, in one embodiment. As further seen, data storage unit 1028 also includes a trusted storage 1029 to store sensitive information to be protected. Further, an audio V/O 1024 may be coupled to second bus 1020.

FIG. 14 depicts an IoT environment that may include wearable devices or other small form factor IoT devices. In one particular implementation, wearable module 1300 may be an Intel® Curie™ module that includes multiple components adapted within a single small module that can be implemented as all or part of a wearable device. As seen, module 1300 includes a core 1310 (of course in other embodiments more than one core may be present). Such a core may be a relatively low complexity in-order core, such as based on an Intel Architecture® Quark™ design. In some embodiments, core 1310 may implement a Trusted Execution Environment (TEE). Core 1310 couples to various components including a sensor hub 1320, which may be configured to interact with a plurality of sensors 1380, such as one or more biometric, motion, environmental or other sensors. A power delivery circuit 1330 is present, along with a non-volatile storage 1340. In an embodiment, this circuit may include a rechargeable battery and a recharging circuit, which may in one embodiment receive charging power wirelessly. One or more input/output (IO) interfaces 1350, such as one or more interfaces compatible with one or more of USB/SPI/I2C/GPIO protocols, may be present. In addition, a wireless transceiver 1390, which may be a Bluetooth™ low energy or other short-range wireless transceiver is present to enable wireless communications as described herein. In different implementations a wearable module can take many other forms. Wearable and/or IoT devices have, in comparison with a typical general-purpose CPU or a GPU, a small form factor, low power requirements, limited instruction sets, relatively slow computation throughput, or any of the above.

Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as (a) a computer program product that may include one or more machine readable media having stored thereon instructions that may be used to program a processing system or other electronic device to perform the methods or (b) at least one storage medium having instructions stored thereon for causing a system to perform the methods. The term “machine readable medium” or “storage medium” used herein shall include any medium that is capable of storing or encoding a sequence of instructions (transitory media, including signals, or non-transitory media) for execution by the machine and that cause the machine to perform any one of the methods described herein. The term “machine readable medium” or “storage medium” shall accordingly include, but not be limited to, memories such as solid-state memories, optical and magnetic disks, read-only memory (ROM), programmable ROM (PROM), erasable PROM (EPROM), electrically EPROM (EEPROM), a disk drive, a floppy disk, a compact disk ROM (CD-ROM), a digital versatile disk (DVD), flash memory, a magneto-optical disk, as well as more exotic mediums such as machine-accessible biological state preserving or signal preserving storage. A medium may include any mechanism for storing, transmitting, or receiving information in a form readable by a machine, and the medium may include a medium through which the program code may pass, such as antennas, optical fibers, communications interfaces, and the like. Program code may be transmitted in the form of packets, serial data, parallel data, and the like, and may be used in a compressed or encrypted format. Furthermore, it is common in the art to speak of software, in one form or another (e.g., program, procedure, process, application, module, logic, and so on) as taking an action or causing a result. Such expressions are merely a shorthand way of stating that the execution of the software by a processing system causes the processor to perform an action or produce a result.

A module as used herein refers to any hardware, software, firmware, or a combination thereof. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices. However, in another embodiment, logic also includes software or code integrated with hardware, such as firmware or micro-code.

### EXAMPLES

Various examples sets are now addressed. Each set may have an “Example 1” and an “Example 2” that references “Example”. Such a reference is to the Example 1 of the same example set.

### Example Set 1

Example 1. A system comprising: a robotic arm (5); an attachment (6) that is separably coupled to the robotic arm; a first zone of suction cups (1) and a second zone of suction cups (2); at least one distance sensor (4) and at least one weight sensor (3) both coupled to the attachment; at least one check valve (11), wherein the first and second zones of suction cups are separably coupled to a negative pressure source (8) via the at least one check valve; wherein: (a) the first zone of suction cups have opposing first and second ends, the second ends coupling the first zone of suction cups to the attachment, (b) the second zone of suction cups have opposing first and second ends, the second ends coupling the second zone of suction cups to the attachment, (c) the first ends of the first zone of suction cups are arranged in a first plane (9), and (d) the first ends of the second zone of suction cups are arranged in a second plane (10) that is non-coplanar with the first plane.

See, e.g., FIGS. 3 and 6A-6B.

In certain embodiments, the attachment may be uncoupled to any robotic arm and/or vacuum source. For example, the attachment may be sold separately (and/or shipped separately in its own box or package) and be used to modify already existing and in place robotic arms. See the following example.

Alternative version of example 1. A system comprising: an attachment (6) that is to separably couple to a robotic arm; a first zone of suction cups (1) and a second zone of suction cups (2); at least one distance sensor (4) and at least one weight sensor (3) both coupled to the attachment; at least one check valve (11), wherein the first and second zones of suction cups are separably coupled to a negative pressure source (8) via the at least one check valve; wherein: (a) the first zone of suction cups have opposing first and second ends, the second ends coupling the first zone of suction cups to the attachment, (b) the second zone of suction cups have opposing first and second ends, the second ends coupling the second zone of suction cups to the attachment, (c) the first ends of the first zone of suction cups are arranged in a first plane (9), and (d) the first ends of the second zone of suction cups are arranged in a second plane (10) that is non-coplanar with the first plane.

Example 2. The system of example 1, wherein: the second zone of suction cups couple to the attachment via a linkage assembly; in an open configuration the second plane is parallel to the first plane; in a closed configuration the second plane is orthogonal to the first plane; in a transitory configuration the second plane is neither parallel nor orthogonal to the first plane.

See, e.g., FIGS. 7A, 7B, 7C.

Example 3. The system of example 2 comprising a motor (20) that is coupled to the attachment, wherein: the linkage assembly includes a driving link (13) that couples the linkage assembly to the motor, an output link (12) that couples the linkage assembly to the second zone of suction cups, and a connecting link (14) which couples the driving link to the output link.

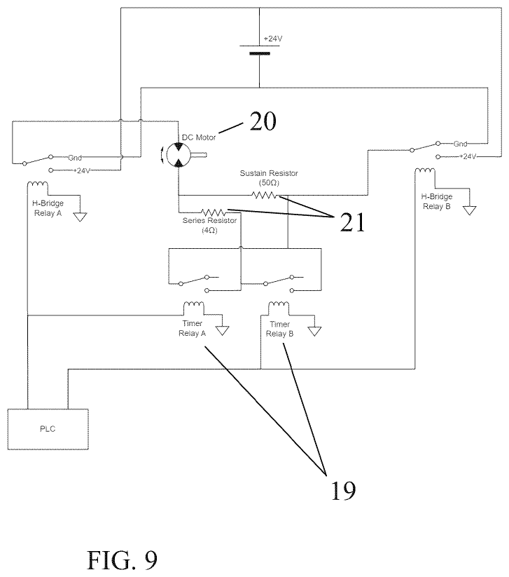

See, e.g., FIGS. 7B and 9.

Example 4. The system of example 3, wherein: the connecting link couples to the driving link at a first pivot (15); the connecting link couples to the output link at a second pivot (16); the output link couples to the attachment at a third pivot (17); in the open configuration a third plane (18) intersects the first, second, and third pivots and the third pivot is between the first and second pivots; in the closed configuration the third plane intersects the first, second, and third pivots and the first pivot is between the second and third pivots.

Example 5. The system according to any of examples 2-4, wherein: in the open configuration the linkage assembly is locked; in the closed configuration the linkage assembly is locked; in the transitory configuration the linkage assembly is unlocked.

Example 6. The system according to example 5, wherein: a first force is required from the motor to move the linkage assembly when the linkage assembly is locked; a second force is required from the motor to move the linkage assembly when the linkage assembly is unlocked; the first force is greater than the second force.

For example, the first and second forces may include differing torque levels.

Example 7. The system according to example 5, wherein: the linkage assembly has a first mechanical advantage when the linkage assembly is locked; the linkage assembly has a second mechanical advantage when the linkage assembly is locked; the first mechanical advantage is greater than the second mechanical advantage.

Example 8. The system according to any of examples 1-7 comprising at least one time delay relay (19) coupled the motor.

See, for example, FIG. 9.

Example 9. The system of example 8, wherein the at least one time delay relay includes a time delay off relay.

Example 10. The system according to any of examples 8-9 comprising at least one resistor (21) coupled to the at least one time delay relay, wherein: a first current level is communicated to the motor when the time delay relay is open; a second current level is communicated to the motor when the time delay relay is closed; the first and second current levels are unequal to each other; the first and second current levels are both greater than 0 amps.

Example 11. The system of example 3, wherein: a first current level is communicated to the motor during a first time period after initiating a change from the open or closed configuration; a second current level is communicated to the motor during a second time period immediately after the first time period; the first current level is higher than the second current level; the first time period is greater than 1 ms and less than 60 seconds.

Thus, embodiments are not limited to use of time delays but may use, for example, resistor capacitor (RC) timing circuits and the like.

Example 12. The system according to any of examples 2-11, wherein: the first zone of suction cups has a width (22) between 100 and 250 mm and a height (23) between 100 and 250 mm; the second zone of suction cups has a width between 100 and 250 mm and a height between 100 and 250 mm.

The relatively small size allows the system to be used with smaller boxes and similar objects by offsetting the small sizes with the, for example, the linkage assembly and articulating/translating zone1 and/or zone2.

Example 13. The system according to any of examples 2-7, wherein: in a non-translated state and the open state, the first zone of suction cups is a first distance from the second zone of suction cups; in a translated state and the open state, the first zone of suction cups is a second distance from the second zone of suction cups; the second distance is greater than the first distance.

Example 14. The system of example 13 comprising a rail, wherein the first zone of suction cups translates along the rail when transitioning between the non-translated and translated states.

Example 15. The system according to any of examples 2-14 comprising at least one machine-readable medium having stored thereon data which, if used by at least one machine, causes the at least one machine to perform operations (1600) comprising: sense a location of a box using the at least one distance sensor (1602), wherein the box is located in a first position (24); move the first zone of suction cups forward towards the box to couple the first zone of suctions cups to the box (1605); apply suction to the first zone of suction cups (1606) to grip the box; raise the box to a second position (25) in response to at least one of: (a) moving the first zone of suction cups backwards away from the first position, and (b) tilting the first zone of suction cups in a first direction about a first axis (23) (1607); change the second zone of suction cups from the open configuration to the transitory configuration and determine whether the second zone of suction cups is impeded from changing into the closed configuration (1610); in response to determining the second zone of suction cups is impeded from changing into the closed configuration, further tilting the first zone of suction cups in the first direction about the first axis (1612); in response to determining the second zone of suction cups is not impeded from changing into the closed configuration and has transition to the closed configuration, applying suction to the second zone of suction cups (1614) to grip the box; tilt the first zone of suction cups in a second direction about the first axis, the second direction being opposite the first direction (1615).

Sec, e.g., FIGS. 15-16. “Front grasping” such as that addressed in FIGS. 15-16 can be challenging. For example, with a 15 kilogram box and a 150 square mm suction cup zone with 16 suction cups, the required individual suction cup force is: 9.18N for top grasping (see, e.g., FIG. 17) vs 30.6N for front grasping. To front-grasp such a box, the gripper must be designed for top-grasping a 50 kg (110 lbs) box. Such a scenario is further complicated due to porous cardboard boxes which require up to 10× more force compared to solid-surface materials (e.g., glass). Box damage due to tearing is also a major concern for boxes >20 in in length. Embodiments addressed herein may be use to front grasp a box in, for example, a shipping container where the shipping container's relatively low ceiling prohibits top grasping.

Example 16. The system of example 15, the operations comprising raise the box to a second position (25) in response to simultaneously: (a) moving the first zone of suction cups backwards away from the first position, and (b) tilting the first zone of suction cups in a first direction about a first axis (23).

Example 17. The system according to any of examples 2-14 comprising at least one machine-readable medium having stored thereon data which, if used by at least one machine, causes the at least one machine to perform operations (2000) comprising: sense a location of a box using the at least one distance sensor (2002), wherein the box is located in a first position; translate the first zone of suction cups away from the second zone of suction cups (2004); move the first zone of suction cups forward towards the box to couple the first zone of suctions cups to the box (2006); apply suction to the first zone of suction cups (2007) to grip the box; raise the box to a second position (25) in response to at least one of: (a) moving the first zone of suction cups backwards away from the first position, and (b) tilting the first zone of suction cups in a first direction about a first axis (2008); change the second zone of suction cups from the open configuration to the transitory configuration and determine whether the second zone of suction cups is impeded from changing into the closed configuration (2011); in response to determining the second zone of suction cups is impeded from changing into the closed configuration, further translating the first zone of suction cups away from the second zone of suction cups (2013); in response to determining the second zone of suction cups is not impeded from changing into the closed configuration and has transition to the closed configuration, applying suction to the second zone of suction cups (2017) to grip the box; tilt the first zone of suction cups in a second direction about the first axis, the second direction being opposite the first direction (2018).

See FIGS. 19-20.

Example 18. The system of example 17, the operations moving the first zone of suction cups forward towards the box to couple the first zone of suctions cups to the box in response to translating the first zone of suction cups away from the second zone of suction cups.

Example 19. The system of example 17, the operations comprising raising the box to a second position (25) in response to simultaneously: (a) moving the first zone of suction cups backwards away from the first position, and (b) tilting the first zone of suction cups in a first direction about a first axis (2008).

Example 20. The system according to any of examples 2-14 comprising at least one machine-readable medium having stored thereon data which, if used by at least one machine, causes the at least one machine to perform operations (1800) comprising: sense a location of a box using the at least one distance sensor (1802), wherein the box is located in a first position (26); move the first zone of suction cups downward towards the box to couple the first zone of suctions cups to the box (1805); apply suction to the first zone of suction cups (1806) to grip the box; change the second zone of suction cups from the open configuration to the transitory configuration and determine whether the second zone of suction cups is impeded from changing into the closed configuration (1808); in response to determining the second zone of suction cups is impeded from changing into the closed configuration, tilting the first zone of suction cups in a first direction about a first axis (27) (1810); in response to determining the second zone of suction cups is not impeded from changing into the closed configuration and has transition to the closed configuration, applying suction to the second zone of suction cups (1812) to grip the box; tilt the first zone of suction cups in a second direction about the first axis, the second direction being opposite the first direction (1813).

See, e.g., FIGS. 17-18.

Example 21. The system according to any of examples 2-14 comprising at least one machine-readable medium having stored thereon data which, if used by at least one machine, causes the at least one machine to perform operations (2200) comprising: sense a location of a box using the at least one distance sensor (2202), wherein the box is located in a first position; translate the first zone of suction cups away from the second zone of suction cups (2204); move the first zone of suction cups downward towards the box to couple the first zone of suctions cups to the box (2206); apply suction to the first zone of suction cups (2207) to grip the box; change the second zone of suction cups from the open configuration to the transitory configuration and determine whether the second zone of suction cups is impeded from changing into the closed configuration (2209); in response to determining the second zone of suction cups is impeded from changing into the closed configuration, further translating the first zone of suction cups away from the second zone of suction cups (2213); in response to determining the second zone of suction cups is not impeded from changing into the closed configuration and has transition to the closed configuration, applying suction to the second zone of suction cups (2215) to grip the box; tilt the first zone of suction cups in a second direction about the first axis, the second direction being opposite the first direction (2216).

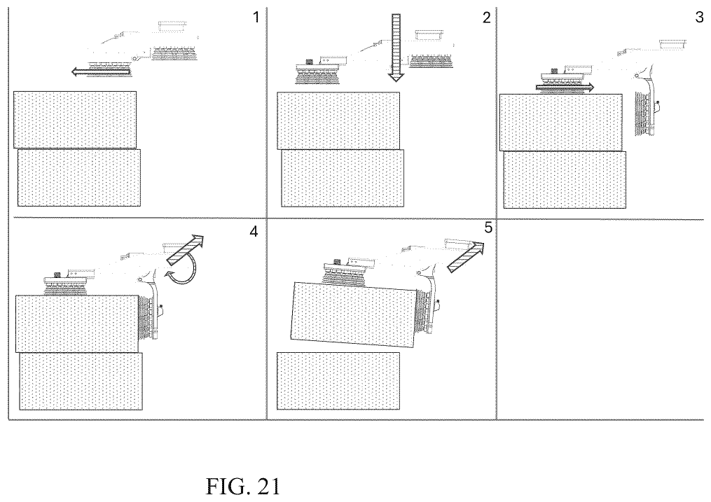

See, e.g., FIGS. 21-22.

Example 22. The system of example 21, the operations comprising moving the first zone of suction cups downward towards the box to couple the first zone of suctions cups to the box (2206) in response to translating the first zone of suction cups away from the second zone of suction cups (2204).

Example 23. The system according to any of examples 1-22, comprising an additional pivot (29), wherein the second zone of suction cups couples to the robotic arm via the pivot.

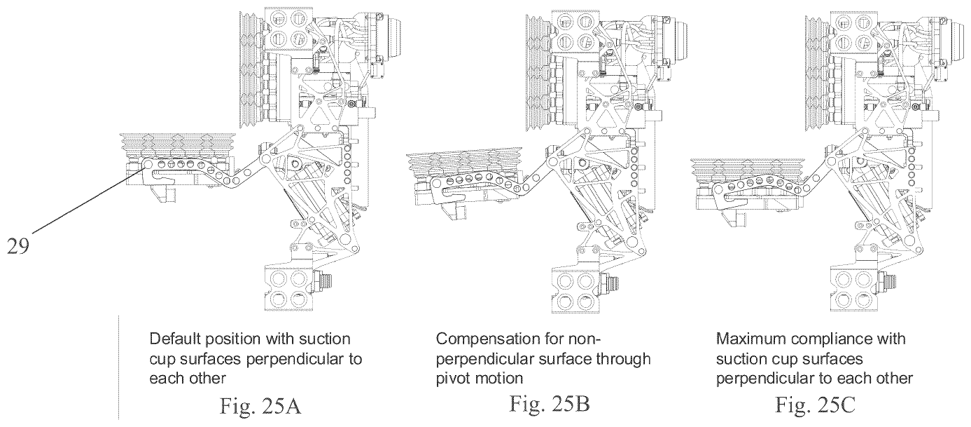

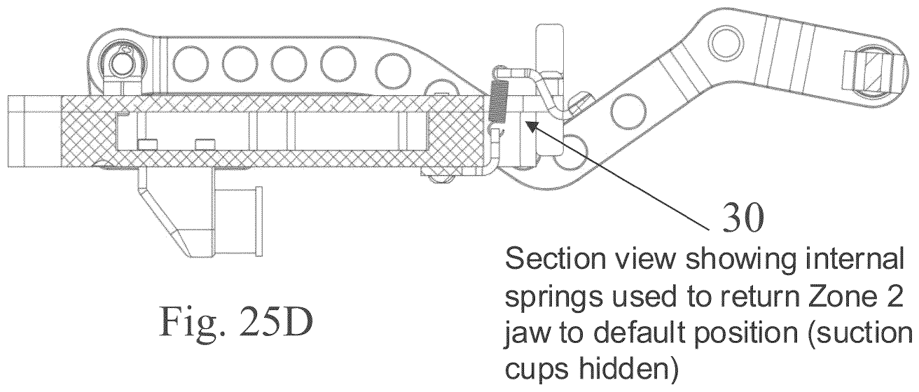

See, for example, FIGS. 25A, 25B, 25C, 25D. As a result, the embodiment accommodates misalignment due to, for example, sensor measurements or missegmentation in computer vision. As used herein, computer vision is a form of distance sensor. For example, compare the maximum compliance in FIG. 25C as compared to no compliance in FIG. 25A. In an embodiment, mechanical tolerance adjustment allows zone2 to accommodate up to 40 mm of misalignment of the target box and still contact it perpendicularly. This is achieved by an additional hinge (29) in the link that allows alignment even when the zone has not moved to 100% of its travel distance. This is also achieved by compressibility of the suction cups.

Example 24. The system of example 23 comprising at least one resilient member coupled to the second zone of suction cups.

### Second Example Set

Example 1. A system comprising: a first zone of suction apertures coupled to a first distance sensor; a second zone of suction apertures coupled to a second distance sensor; a robotic arm coupled to the first and second zones of suction apertures; wherein: (a) the first zone of suction apertures is arranged in a first plane, and (b) the second zone of suction apertures is arranged in a second plane that is non-coplanar with the first plane.

Alternatives to suction cups in robotics include, for example, magnetic grippers for ferromagnetic materials, and foam grippers which can conform to uneven surfaces, depending on the specific application and object properties involved. For example, a foam gripper may have a foam layer with apertures. Suction or negative pressure can be applied via through the foam or via apertures in the foam. Such apertures would also exist in the above mentioned suction cups. Thus, “suction apertures” may apply to suction cups, foam based grippers, and the like. Regarding magnetic grippers, instead of turning suction on/off or varying the amount of suction, electromagnetic materials may vary grip strength by turning current to the electromagnet on/off or vary the amount of current.

The plane may include only a portion of certain apertures. For example, 50% of the first zone of apertures may be included in the first plane and another 50% of the first zone of apertures may be included in a third plane that is non-coplanar with either of the first or second planes.

Alternative version of example 1. A system comprising: a first zone of suction apertures (1) and a second zone of suction apertures (2) collectively coupled to at least one distance sensor; a robotic arm (5) coupled to the first and second zones of suction apertures; wherein: (a) the first zone of suction apertures is arranged in a first plane (9), and (b) the second zone of suction apertures is arranged in a second plane (10) that is non-coplanar with the first plane.

Alternative version of example 1. A system comprising: a first zone of suction apertures coupled to a first distance sensor; a second zone of suction apertures coupled to a second distance sensor; wherein the first and second zones of suction apertures are to couple to a robotic arm; wherein: (a) the first zone of suction apertures is arranged in a first plane, and (b) the second zone of suction apertures is arranged in a second plane that is non-coplanar with the first plane.

Example 2. The system of example 1, wherein: the first and second zones of suction apertures couple to each other via a linkage assembly; in an open configuration the second plane is parallel to the first plane; in a closed configuration the second plane is orthogonal to the first plane; in a transitory configuration the second plane is neither parallel nor orthogonal to the first plane.

Alternative version of example 2. The system of example 1, wherein: the first and second zones of suction apertures couple to each other via a linkage assembly; in an open configuration the second plane is at a first angle parallel to the first plane; in a closed configuration the second plane is at a second angle to the first plane; in a transitory configuration the second plane is at a third angle to the first plane.

For example, the first angle may be parallel (0 degrees) but is not necessarily so in all embodiments. For example, the second angle may be orthogonal (or 90 degrees) but is not necessarily so in all embodiments. For example, the third angle may be between 0 and 90 degrees but is not necessarily so in all embodiments.

Example 3. The system of example 2 comprising a motor coupled to the linkage assembly.

Example 4. The system of example 3, wherein: the linkage assembly includes first, second, and third links; the second link couples to the first link at a first pivot; the second link couples to the third link at a second pivot; the third link couples to a third pivot; in the open configuration a third plane intersects the first, second, and third pivots and the third pivot is between the first and second pivots; in the closed configuration the third plane intersects the first, second, and third pivots and the first pivot is between the second and third pivots.

Example 5. The system according to any of examples 2-4, wherein: in the open configuration the linkage assembly is locked; in the closed configuration the linkage assembly is locked; in the transitory configuration the linkage assembly is unlocked.

Example 6. The system according to any of examples 3-4, wherein: a first force is required from the motor to move the linkage assembly when the linkage assembly is locked; a second force is required from the motor to move the linkage assembly when the linkage assembly is unlocked; the first force is greater than the second force.

Example 7. The system according to any of examples 3-4, wherein: the linkage assembly has a first mechanical advantage when the linkage assembly is locked; the linkage assembly has a second mechanical advantage when the linkage assembly is locked; the first mechanical advantage is greater than the second mechanical advantage.

Example 8. The system according to any of examples 3-4 or 6-7 comprising at least one time delay relay coupled the motor.

Example 9. The system of example 8, wherein the at least one time delay relay includes a time delay off relay.

Example 10. The system according to any of examples 8-9 comprising at least one resistor coupled to the at least one time delay relay, wherein: a first current level is communicated to the motor when the time delay relay is open; a second current level is communicated to the motor when the time delay relay is closed; the first and second current levels are unequal to each other; the first and second current levels are both greater than 0 amps.

Example 11. The system of example 3, wherein: a first current level is communicated to the motor during a first time period after initiating a change from the open or closed configuration; a second current level is communicated to the motor during a second time period immediately after the first time period; the first current level is higher than the second current level; the first time period is greater than 1 ms and less than 60 seconds.

Example 12. The system according to any of examples 2-11, wherein: the first zone of suction apertures has a width between 100 and 250 mm and a height between 100 and 250 mm; the second zone of suction apertures has a width between 100 and 250 mm and a height between 100 and 250 mm.

Example 13. The system according to any of examples 2-7, wherein: in a non-translated state and the open state, the first zone of suction apertures is a first distance from the second zone of suction apertures; in a translated state and the open state, the first zone of suction apertures is a second distance from the second zone of suction apertures; the second distance is greater than the first distance.

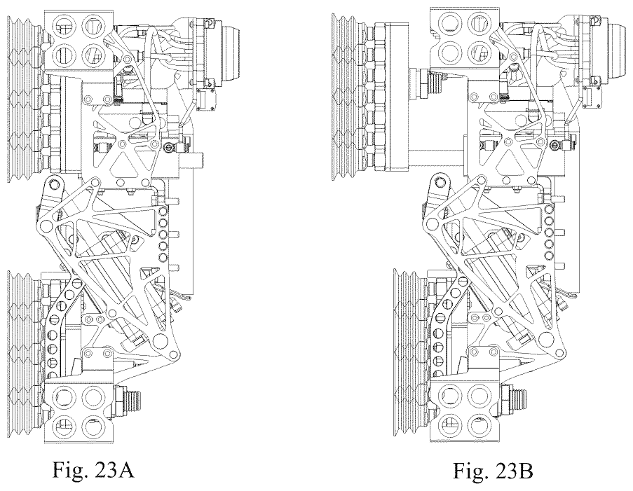

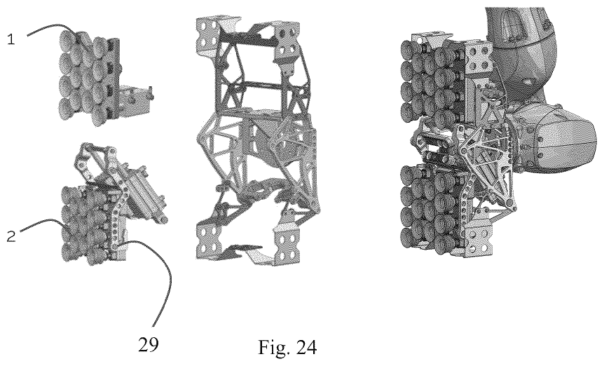

Such a translation may be, for example, “vertical” (see, e.g., FIG. 6A or 19 block 1 and 2) and/or “horizontal” (see, e.g., FIG. 23) with respect to any base zone1 and zone2 are attached. Regarding “horizontal” translation, for example, towards the target box. This enables the gripper to grasp boxes that are otherwise recessed into the boxwall and inaccessible. This is accessible by having the rail oriented 90 degrees from, for example, FIG. 6A.

Example 14. The system of example 13 comprising a rail, wherein the first zone of suction apertures translates along the rail when transitioning between the non-translated and translated states.

Another version of 14. The system of example 13 comprising at least one rail, wherein the first zone of suction apertures translates along the rail when transitioning between the non-translated and translated states.

For example, in an embodiment first and second rails are used to support vertical and horizontal movement. In other embodiments a single rail may rotate to provide varying levels of translation.

Example 15. The system according to any of examples 2-14 comprising at least one machine-readable medium having stored thereon data which, if used by at least one machine, causes the at least one machine to perform operations comprising: sense a location of an object using the at least one distance sensor, wherein the object is located in a first position; move the first zone of suction apertures forward towards the object to couple the first zone of suctions apertures to the object; apply suction to the first zone of suction apertures to grip the object; raise the object to a second position (25) in response to at least one of: (a) moving the first zone of suction apertures backwards away from the first position, and (b) tilting the first zone of suction apertures in a first direction about a first axis (23) (1607); change the second zone of suction apertures from the open configuration to the transitory configuration and determine whether the second zone of suction apertures is impeded from changing into the closed configuration (1610); in response to determining the second zone of suction apertures is impeded from changing into the closed configuration, further tilting the first zone of suction apertures in the first direction about the first axis (1612); in response to determining the second zone of suction apertures is not impeded from changing into the closed configuration and has transition to the closed configuration, applying suction to the second zone of suction apertures (1614) to grip the object; tilt the first zone of suction apertures in a second direction about the first axis, the second direction being opposite the first direction (1615).

As used herein, various flow charts depict a sequence of events. For example, block 2216 may occur after and in response to block 2215 of FIG. 22. However, various examples and or claims may recite steps corresponding to both blocks, but not specify the order or sequence of events for the steps. Thus, there is support herein for various sequence of events. For example 15, “apply suction to the first zone of suction apertures to grip the object” may occur before or after “move the first zone of suction apertures forward towards the object to couple the first zone of suctions apertures to the object”. Further, while some embodiments addressed herein do not list some steps that might be found in other embodiments, still other embodiments may omit even more steps and still be supported by any of the flow chart methods provided herein.

Alternative version of example 15. The system according to any of examples 2-14 comprising at least one machine-readable medium having stored thereon data which, if used by at least one machine, causes the at least one machine to perform operations comprising: raise an object to a second position (25) in response to at least one of: (a) moving the first zone of suction apertures backwards away from the first position, and (b) tilting the first zone of suction apertures in a first direction about a first axis (23) (1607).

Alternative version of example 15. The system according to any of examples 2-14 comprising at least one machine-readable medium having stored thereon data which, if used by at least one machine, causes the at least one machine to perform operations comprising: raise an object to a second position (25) in response to at least one of: (a) moving the first zone of suction apertures backwards away from the first position, and (b) tilting the first zone of suction apertures in a first direction about a first axis (23) (1607); change the second zone of suction apertures from the open configuration to the transitory configuration and determine whether the second zone of suction apertures is impeded from changing into the closed configuration (1610); in response to determining the second zone of suction apertures is impeded from changing into the closed configuration, further tilting the first zone of suction apertures in the first direction about the first axis (1612); in response to determining the second zone of suction apertures is not impeded from changing into the closed configuration and has transition to the closed configuration, applying suction to the second zone of suction apertures (1614) to grip the object; tilt the first zone of suction apertures in a second direction about the first axis, the second direction being opposite the first direction (1615).

Example 16. The system of example 15, the operations comprising raise the object to a second position (25) in response to simultaneously: (a) moving the first zone of suction apertures backwards away from the first position, and (b) tilting the first zone of suction apertures in a first direction about a first axis (23).

Example 17. The system according to any of examples 2-14 comprising at least one machine-readable medium having stored thereon data which, if used by at least one machine, causes the at least one machine to perform operations (2000) comprising: sense a location of an object using the at least one distance sensor (2002), wherein the object is located in a first position; translate the first zone of suction apertures away from the second zone of suction apertures (2004); move the first zone of suction apertures forward towards the object to couple the first zone of suctions apertures to the object (2006); apply suction to the first zone of suction apertures (2007) to grip the object; raise the object to a second position (25) in response to at least one of: (a) moving the first zone of suction apertures backwards away from the first position, and (b) tilting the first zone of suction apertures in a first direction about a first axis (2008); change the second zone of suction apertures from the open configuration to the transitory configuration and determine whether the second zone of suction apertures is impeded from changing into the closed configuration (2011); in response to determining the second zone of suction apertures is impeded from changing into the closed configuration, further translating the first zone of suction apertures away from the second zone of suction apertures (2013); in response to determining the second zone of suction apertures is not impeded from changing into the closed configuration and has transition to the closed configuration, applying suction to the second zone of suction apertures (2017) to grip the object; tilt the first zone of suction apertures in a second direction about the first axis, the second direction being opposite the first direction (2018).

See FIGS. 19-20.

Such a translation may be, for example, “vertical” (see, e.g., FIG. 6A or 19 block 1 and 2) and/or “horizontal” (see, e.g., FIG. 23) with respect to any base zone1 and zone2 are attached.

Another version of example 17. The system according to any of examples 2-14 comprising at least one machine-readable medium having stored thereon data which, if used by at least one machine, causes the at least one machine to perform operations (2000) comprising: raise an object to a second position (25) in response to at least one of: (a) moving the first zone of suction apertures backwards away from the first position, and (b) tilting the first zone of suction apertures in a first direction about a first axis (2008).

Another version of example 17. The system according to any of examples 2-14 comprising at least one machine-readable medium having stored thereon data which, if used by at least one machine, causes the at least one machine to perform operations (2000) comprising: raise an object to a second position (25) in response to at least one of: (a) moving the first zone of suction apertures backwards away from the first position, and (b) tilting the first zone of suction apertures in a first direction about a first axis (2008); change the second zone of suction apertures from the open configuration to the transitory configuration and determine whether the second zone of suction apertures is impeded from changing into the closed configuration (2011); in response to determining the second zone of suction apertures is impeded from changing into the closed configuration, further translating the first zone of suction apertures away from the second zone of suction apertures (2013); in response to determining the second zone of suction apertures is not impeded from changing into the closed configuration and has transition to the closed configuration, applying suction to the second zone of suction apertures (2017) to grip the object; tilt the first zone of suction apertures in a second direction about the first axis, the second direction being opposite the first direction (2018).

Example 18. The system of example 17, the operations moving the first zone of suction apertures forward towards the object to couple the first zone of suctions apertures to the object in response to translating the first zone of suction apertures away from the second zone of suction apertures.

Example 19. The system of example 17, the operations comprising raising the object to a second position (25) in response to simultaneously: (a) moving the first zone of suction apertures backwards away from the first position, and (b) tilting the first zone of suction apertures in a first direction about a first axis (2008).

Example 20. The system according to any of examples 2-14 comprising at least one machine-readable medium having stored thereon data which, if used by at least one machine, causes the at least one machine to perform operations (1800) comprising: sense a location of an object using the at least one distance sensor (1802), wherein the object is located in a first position (26); move the first zone of suction apertures downward towards the object to couple the first zone of suctions apertures to the object (1805); apply suction to the first zone of suction apertures (1806) to grip the object; change the second zone of suction apertures from the open configuration to the transitory configuration and determine whether the second zone of suction apertures is impeded from changing into the closed configuration (1808); in response to determining the second zone of suction apertures is impeded from changing into the closed configuration, tilting the first zone of suction apertures in a first direction about a first axis (27) (1810); in response to determining the second zone of suction apertures is not impeded from changing into the closed configuration and has transition to the closed configuration, applying suction to the second zone of suction apertures (1812) to grip the object; tilt the first zone of suction apertures in a second direction about the first axis, the second direction being opposite the first direction (1813).

See, e.g., FIGS. 17-18.

Another version of example 20. The system according to any of examples 2-14 comprising at least one machine-readable medium having stored thereon data which, if used by at least one machine, causes the at least one machine to perform operations (1800) comprising: change the second zone of suction apertures from the open configuration to the transitory configuration and determine whether the second zone of suction apertures is impeded from changing into the closed configuration (1808); in response to determining the second zone of suction apertures is impeded from changing into the closed configuration, tilting the first zone of suction apertures in a first direction about a first axis (27) (1810); in response to determining the second zone of suction apertures is not impeded from changing into the closed configuration and has transition to the closed configuration, applying suction to the second zone of suction apertures (1812) to grip the object; tilt the first zone of suction apertures in a second direction about the first axis, the second direction being opposite the first direction (1813).

Example 21. The system according to any of examples 2-14 comprising at least one machine-readable medium having stored thereon data which, if used by at least one machine, causes the at least one machine to perform operations (2200) comprising: sense a location of an object using the at least one distance sensor (2202), wherein the object is located in a first position; translate the first zone of suction apertures away from the second zone of suction apertures (2204); move the first zone of suction apertures downward towards the object to couple the first zone of suctions apertures to the object (2206); apply suction to the first zone of suction apertures (2207) to grip the object; change the second zone of suction apertures from the open configuration to the transitory configuration and determine whether the second zone of suction apertures is impeded from changing into the closed configuration (2209); in response to determining the second zone of suction apertures is impeded from changing into the closed configuration, further translating the first zone of suction apertures away from the second zone of suction apertures (2213); in response to determining the second zone of suction apertures is not impeded from changing into the closed configuration and has transition to the closed configuration, applying suction to the second zone of suction apertures (2215) to grip the object; tilt the first zone of suction apertures in a second direction about the first axis, the second direction being opposite the first direction (2216).

See, e.g., FIGS. 21-22.

Such a translation may be, for example, “vertical” (see, e.g., FIG. 6A or 19 block 1 and 2) and/or “horizontal” (see, e.g., FIG. 23) with respect to any base zone1 and zone2 are attached.

Another version of example 21. The system according to any of examples 2-14 comprising at least one machine-readable medium having stored thereon data which, if used by at least one machine, causes the at least one machine to perform operations (2200) comprising: change the second zone of suction apertures from the open configuration to the transitory configuration and determine whether the second zone of suction apertures is impeded from changing into the closed configuration (2209); in response to determining the second zone of suction apertures is impeded from changing into the closed configuration, further translating the first zone of suction apertures away from the second zone of suction apertures (2213); in response to determining the second zone of suction apertures is not impeded from changing into the closed configuration and has transition to the closed configuration, applying suction to the second zone of suction apertures (2215) to grip the object; tilt the first zone of suction apertures in a second direction about the first axis, the second direction being opposite the first direction (2216).

Example 22. The system of example 21, the operations comprising moving the first zone of suction apertures downward towards the object to couple the first zone of suctions apertures to the object (2206) in response to translating the first zone of suction apertures away from the second zone of suction apertures (2204).

Example 23. The system according to any of examples 1-22, comprising an additional pivot, wherein the second zone of suction apertures couples to the robotic arm via the pivot.

Example 24. The system of example 23 comprising at least one resilient member coupled to the second zone of suction apertures.

The foregoing description of the embodiments of the invention has been presented for the purposes of illustration and description. It is not intended to be exhaustive or to limit the invention to the precise forms disclosed. This description and the claims following include terms, such as left, right, top, bottom, over, under, upper, lower, first, second, etc. that are used for descriptive purposes only and are not to be construed as limiting. For example, terms designating relative vertical position refer to a situation where a side of a substrate is the “top” surface of that substrate; the substrate may actually be in any orientation so that a “top” side of a substrate may be lower than the “bottom” side in a standard terrestrial frame of reference and still fall within the meaning of the term “top.” The term “on” as used herein (including in the claims) does not indicate that a first layer “on” a second layer is directly on and in immediate contact with the second layer unless such is specifically stated; there may be a third layer or other structure between the first layer and the second layer on the first layer. The embodiments of a device or article described herein can be manufactured, used, or shipped in a number of positions and orientations. Persons skilled in the relevant art can appreciate that many modifications and variations are possible in light of the above teaching. Persons skilled in the art will recognize various equivalent combinations and substitutions for various components shown in the Figures. It is therefore intended that the scope of the invention be limited not by this detailed description, but rather by the claims appended hereto.

What is claimed is:

1. A system comprising:
a robotic arm;
an attachment that is separably coupled to the robotic arm;
a first zone of suction cups and a second zone of suction cups;
at least one distance sensor and at least one weight sensor both coupled to the attachment;
at least one check valve, wherein the first and second zones of suction cups are separably coupled to a negative pressure source via the at least one check valve;
wherein: (a) the first zone of suction cups have opposing first and second ends, the second ends coupling the first zone of suction cups to the attachment, (b) the second zone of suction cups have opposing first and second ends, the second ends coupling the second zone of suction cups to the attachment, (c) the first ends of the first zone of suction cups are arranged in a first plane, and (d) the first ends of the second zone of suction cups are arranged in a second plane that is non-coplanar with the first plane.

2. The system of claim 1, wherein:
the second zone of suction cups couple to the attachment via a linkage assembly;
in an open configuration the second plane is parallel to the first plane;
in a closed configuration the second plane is orthogonal to the first plane;
in a transitory configuration the second plane is neither parallel nor orthogonal to the first plane.

3. The system of claim 2 comprising a motor that is coupled to the attachment, wherein:
the linkage assembly includes a driving link that couples the linkage assembly to the motor, an output link that couples the linkage assembly to the second zone of suction cups, and a connecting link which couples the driving link to the output link.

4. The system of claim 3, wherein:
the connecting link couples to the driving link at a first pivot;
the connecting link couples to the output link at a second pivot;
the output link couples to the attachment at a third pivot;
in the open configuration a third plane intersects the first, second, and third pivots and the third pivot is between the first and second pivots;
in the closed configuration the third plane intersects the first, second, and third pivots and the first pivot is between the second and third pivots.

5. The system of claim 2, wherein:
in the open configuration the linkage assembly is locked;
in the closed configuration the linkage assembly is locked;
in the transitory configuration the linkage assembly is unlocked.

6. The system according to claim 5, wherein:
the linkage assembly has a first mechanical advantage when the linkage assembly is locked;
the linkage assembly has a second mechanical advantage when the linkage assembly is locked;
the first mechanical advantage is greater than the second mechanical advantage.

7. The system of claim 2 comprising:
a motor that is coupled to the attachment; and
at least one time delay relay coupled the motor.

8. The system of claim 7, wherein:
a first current level is communicated to the motor during a first time period after initiating a change from at least one of: (a) the open configuration to the closed configuration, or (b) the closed configuration to the open configuration;
a second current level is communicated to the motor during a second time period immediately after the first time period;
the first current level is higher than the second current level;
the first time period is greater than 1 ms and less than 60 seconds.

9. The system of claim 1, wherein:
the first zone of suction cups has a width between 100 and 250 mm and a height between 100 and 250 mm;
the second zone of suction cups has a width between 100 and 250 mm and a height between 100 and 250 mm.

10. The system of claim 2, wherein:
in a non-translated state and the open configuration, the first zone of suction cups is a first distance from the second zone of suction cups;
in a translated state and the open configuration, the first zone of suction cups is a second distance from the second zone of suction cups;
the second distance is greater than the first distance.

11. The system of claim 10 comprising a rail, wherein the first zone of suction cups translates along the rail when transitioning between the non-translated state and the translated state.

12. The system of claim 2 comprising at least one machine-readable medium having stored thereon data which, if used by at least one machine, causes the at least one machine to perform operations comprising:
sense a location of a box using the at least one distance sensor, wherein the box is located in a first position;
move the first zone of suction cups forward towards the box to couple the first zone of suctions cups to the box;
apply suction to the first zone of suction cups to grip the box;
raise the box to a second position in response to at least one of: (a) moving the first zone of suction cups backwards away from the first position, and (b) tilting the first zone of suction cups in a first direction about a first axis;
change the second zone of suction cups from the open configuration to the transitory configuration and determine whether the second zone of suction cups is impeded from changing into the closed configuration;
in response to determining the second zone of suction cups is impeded from changing into the closed configuration, further tilting the first zone of suction cups in the first direction about the first axis;
in response to determining the second zone of suction cups is not impeded from changing into the closed configuration and has transition to the closed configuration, applying suction to the second zone of suction cups to grip the box;
tilt the first zone of suction cups in a second direction about the first axis, the second direction being opposite the first direction.

13. The system of claim 12, the operations comprising raise the box to a second position in response to simultaneously: (a) moving the first zone of suction cups backwards away from the first position, and (b) tilting the first zone of suction cups in a first direction about a first axis.

14. The system of claim 2 comprising at least one machine-readable medium having stored thereon data which, if used by at least one machine, causes the at least one machine to perform operations comprising:
sense a location of a box using the at least one distance sensor, wherein the box is located in a first position;
translate the first zone of suction cups away from the second zone of suction cups;
move the first zone of suction cups forward towards the box to couple the first zone of suctions cups to the box;
apply suction to the first zone of suction cups to grip the box;
raise the box to a second position in response to at least one of: (a) moving the first zone of suction cups backwards away from the first position, and (b) tilting the first zone of suction cups in a first direction about a first axis;
change the second zone of suction cups from the open configuration to the transitory configuration and determine whether the second zone of suction cups is impeded from changing into the closed configuration;
in response to determining the second zone of suction cups is impeded from changing into the closed configuration, further translating the first zone of suction cups away from the second zone of suction cups;
in response to determining the second zone of suction cups is not impeded from changing into the closed configuration and has transition to the closed configuration, applying suction to the second zone of suction cups to grip the box;
tilt the first zone of suction cups in a second direction about the first axis, the second direction being opposite the first direction.

15. The system of claim 14, the operations moving the first zone of suction cups forward towards the box to couple the first zone of suctions cups to the box in response to translating the first zone of suction cups away from the second zone of suction cups.

16. The system of claim 14, the operations comprising raising the box to a second position in response to simultaneously: (a) moving the first zone of suction cups backwards away from the first position, and (b) tilting the first zone of suction cups in a first direction about a first axis.

17. The system of claim 2 comprising at least one machine-readable medium having stored thereon data which, if used by at least one machine, causes the at least one machine to perform operations comprising:
sense a location of a box using the at least one distance sensor, wherein the box is located in a first position;
move the first zone of suction cups downward towards the box to couple the first zone of suctions cups to the box;
apply suction to the first zone of suction cups to grip the box;
change the second zone of suction cups from the open configuration to the transitory configuration and determine whether the second zone of suction cups is impeded from changing into the closed configuration;
in response to determining the second zone of suction cups is impeded from changing into the closed configuration, tilting the first zone of suction cups in a first direction about a first axis;
in response to determining the second zone of suction cups is not impeded from changing into the closed configuration and has transition to the closed configuration, applying suction to the second zone of suction cups to grip the box;
tilt the first zone of suction cups in a second direction about the first axis, the second direction being opposite the first direction.

18. The system of claim 2 comprising at least one machine-readable medium having stored thereon data which, if used by at least one machine, causes the at least one machine to perform operations comprising:
sense a location of a box using the at least one distance sensor, wherein the box is located in a first position;
translate the first zone of suction cups away from the second zone of suction cups;
move the first zone of suction cups downward towards the box to couple the first zone of suctions cups to the box;
apply suction to the first zone of suction cups to grip the box;
change the second zone of suction cups from the open configuration to the transitory configuration and determine whether the second zone of suction cups is impeded from changing into the closed configuration;
in response to determining the second zone of suction cups is impeded from changing into the closed configuration, further translating the first zone of suction cups away from the second zone of suction cups;
in response to determining the second zone of suction cups is not impeded from changing into the closed configuration and has transition to the closed configuration, applying suction to the second zone of suction cups to grip the box;
tilt the first zone of suction cups about a first axis.

19. The system of claim 18, the operations comprising translating the first zone of suction cups toward the second zone of suction cups.

20. The system of claim 1, comprising:
an additional pivot, wherein the second zone of suction cups couples to the robotic arm via the additional pivot; and
at least one resilient member coupled to the second zone of suction cups.
